(19) United States
(12) Patent Application Publication
(10) Pub. No.: US 2008/0001547 A1
(43) Pub. Date: Jan. 3, 2008

(54) Driving parallel strings of series connected LEDs

(76) Inventor: Sorin L. Negru, San Jose, CA (US)

Correspondence Address: PILLSBURY WINTHROP SHAW PITTMAN LLP, P.O. BOX 10500, MCLEAN, VA, 22102, US

(21) Appl. No.: 11/533,737

(22) Filed: Sep. 20, 2006

Related U.S. Application Data
(60) Provisional application No. 60/718,850, filed on Sep. 20, 2005.

(51) Int. Cl. H05B 33/08

(52) U.S. Cl. 315/189

(57) ABSTRACT

Systems and methods are described that provide an efficient and cost-effective LED driver for controlling strings of LEDs. Embodiments described include an LED driver that comprises an adaptive boost converter and current source that cooperate to provide a desired light output from energized LEDs. Systems and methods are also described that modulate the excitation of the LEDs using a pulsed signal to obtain brightness control. Techniques are described for controlling the operation of individual LEDs in a string of LEDs such that a desired level of light output can be achieved. Embodiments are described in which multicolored LEDs can be included in strings of LEDs and excitation of the individual LEDs can be controlled to obtained a desired color of output.

### CROSS-REFERENCE TO RELATED APPLICATIONS

The present application claims priority from provisional patent application No. 60/718,850, entitled “Method And IC Driver For Parallel Strings Of Series Connected White LEDs,” filed Sep. 20, 2005 which is incorporated herein by reference and for all purposes. The present Application is also related to U.S. non-provisional patent application Ser. No. 11/116,724 entitled “Method And IC Driver For Series Connected R, G, B LEDs,” filed Apr. 28, 2005, which is incorporated herein by reference and for all purposes.

### FIELD OF THE INVENTION

The present disclosure r elates generally to electronic circuits for controlled energizing of light emitting diodes 5 (“LEDs”), and more specifically to high efficiency circuits for controlled energizing of parallel strings of series connected white LEDs (“WLEDs”).

### DESCRIPTION OF RELATED ART

One of the most important functions in various portable devices such as personal digital assistants (“PDAs”), cell phones, digital still cameras, camcorders, etc. is displaying to a user the device's present condition, i.e. a display function. Without a display function, a device's user could not enter data into or retrieve data from the device, i.e. control tie device's operation. Thus, a portable device's display function is essential to its usefulness.

Devices implement their display function in various different ways, e.g. through a display screen such as a liquid crystal display (“LCD”), through a numeric keypad and/or alphanumeric keyboard and their associated markings, through function keys, through an individual point display such as power-on or device-operating indicator, etc.

Due to space limitations in portable devices, these various different types of display function as well as other ancillary functions are performed largely by WLEDs and by red, green, blue (“RGB”) LEDs. Within portable devices, LEDs provide backlighting for panels such as LCDs, dimming of a keypad, or a flash for taking a picture, etc.

Controlling the operation of WLEDs and RGB LEDs requires using a special driver circuit assembled using discrete components or a dedicated integrated circuit (“IC”) controller. For many LEDs connected in various different ways there exists a need for a special driver circuit that provides proper power to the LEDs at minimum cost. What does proper power mean? Proper power means that the special driver circuit must provide voltage and current required so the LEDs emit light independent of the portable device's energy source, e.g. a battery having a voltage (“v”) between 1.5 v and 4.2 v. What does minimum cost means? Minimum cost means that the special driver circuit must energize the LEDs with maximum efficiency thereby extending battery life.

WLED Control

To permit dining, a WLED must be supplied with a voltage between 3.0 v and 4.2 v and a current in the milliampere (“nA”) range. Typical WLED values for energizing the operation of WLEDs are 3.7 v and 20 mA. WLEDs exhibit good matching of threshold voltage due to their physical structure. As illustrated in FIGS. 1 and 2, this particular characteristic of WLEDs is very useful for controller design.

FIG. 1 illustrates one particular configuration for a circuit that energizes the operation of parallel connected LEDs 140, 141, 142 and 143. In FIG. 1, a battery 10 provides power to a conventional IC LED driver 12. An output of LED driver 12 connects in parallel to anodes of LEDs 140, 141, 142 and 143. Connected in this way t LED driver 12 supplies electrical current to LEDs 140, 141, 142 and 143 for energizing their operation. Cathodes of each of LEDs 140, 141, 142 and 143 connect through corresponding series ballast resistors 160, 161, 162 and 163. It will be appreciated that ballast resistors 160, 161, 162 and 163 are wasteful of power. Consequently, circuits such as that depicted in FIG. 1 having LEDs 140, 141, 142 and 143 connected in parallel are an inefficient way to energize operation of LEDs 140, 141, 142 and 143.

FIG. 2 depicts a number of LEDs 240, 241, 242 and 243 connected in series with each other and with a single ballast resistor 26. Connection of the LEDs 240, 241, 242 and 243 in series is much more efficient because it limits power loss to that in single ballast resistor 26. However, LED driver 12 must supply an output voltage that is approximately four times greater than would be required for parallel-connected LEDs (as depicted, e.g., in FIG. 1).

RGB LED Control

Referring to both FIG. 1 and FIG. 2, further problems in the prior art arise when LEDs 140, 141, 142 and 143 or LEDs 240, 241, 242 and 243 comprise a mix of different LED types. For example, when red, green and blue LEDs (RGB LEDs) are mixed (e.g. to obtain white light output), LED driver 12 is more complicated than that for white LEDs (WLEDs) because the three colored LEDs can have significantly different dimming threshold voltages. For example, the dimming threshold voltage for a red LED is approximately 1.9 v, for a blue LED is approximately 3.7 v, and for a green LED is approximately 3.7 v. Resistances of ballast resistors 160, 161, 162 and 163 must be selected accommodate the different dimming threshold voltages of any WLED or RGB LED employed as LEDs 140, 141, 142 and 143 or LEDs 240, 241, 242 and 243.

Furthermore, an LED driver must be capable of supplying a specific combination of bias currents to RGB LEDs to obtain white light, Consequently, compromise must often be made between aesthetics, power consumption (i.e. battery longevity) and circuit complexity (i.e. device cost) when LED drivers are designed for use in portable devices.

### BRIEF SUMMARY

An object of the present disclosure is to provide an efficient LED driver for parallel strings of series connected LEDs. In certain embodiments, these LEDs can comprise combinations of red, blue, green, white and any other desired color LED. Another object of the present disclosure is to provide an adaptive boost converter for parallel strings of series connected WLEDs which energizes their operation with proper power at minimum cost. These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is a circuit diagram of a typical prior art driver for parallel LEDs;

FIG. 2 is a circuit diagram of a typical prior art driver for series-connected LEDs;

FIG. 3 is a circuit diagram depicting a LED driver in accordance with the present disclosure for driving series-connected LEDs;

FIG. 4 is a circuit diagram depicting an adaptive boost converter used for controlling the operation of series-connected LEDs;

FIG. 5 is a simple block diagram of an IC which implements the adaptive boost converter illustrated in FIG. 4;

FIG. 6 is a is a circuit diagram depicting an example of an adaptive boost converter used for controlling the operation of parallel-connected LEDs;

FIG. 7 is timing chart illustrating the association of boost voltage output with interleaved driving of parallel-connected strings of 2, 3 and 4 LEDs;

FIG. 8 is timing chart illustrating the association of boost voltage output with interleaved driving of parallel-connected strings of 2, 3 and 4 LEDs;

FIG. 9 is a block diagram depicting an example of an LED driver for driving LEDs or strings of LEDs; and

FIG. 10 is a is a circuit diagram depicting an example of an adaptive boost converter used for controlling the operation of parallel-connected LEDs.

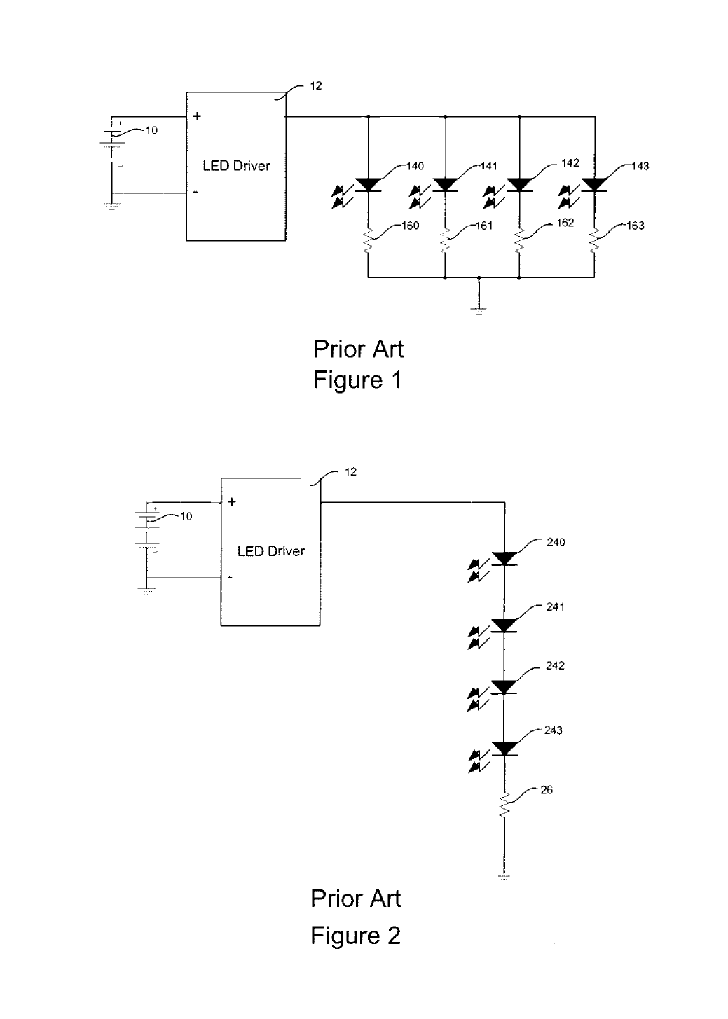

### DETAILED DESCRIPTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Embodiments of the invention provide systems and methods for controlling LEDs. Certain can accommodate heterogeneous combinations of LEDs as well as LEDs of the same type as necessary to obtain a desired color and brightness of light emitted from each of a plurality of LEDs or from a combination of LEDs and strings of LEDs. For the purposes of tis description, reference to LEDs will be understood to be applicable to WLEDs, RGB LEDs and other types of LEDs. Further, certain embodiments of the invention can provide high efficiency LED drivers that minimize power consumption, particularly in battery-powered devices.

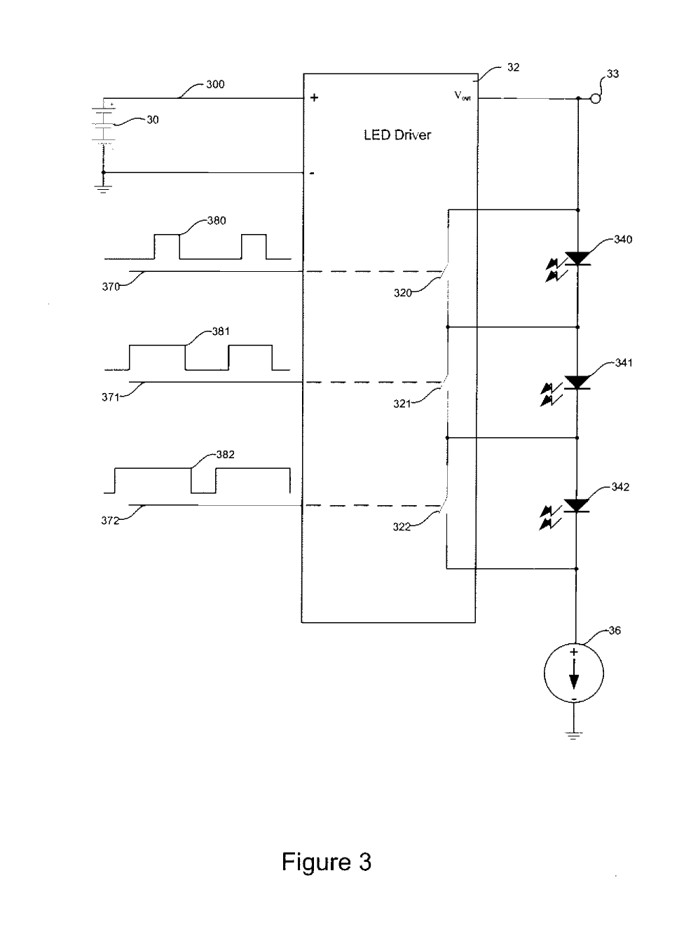

Referring to FIG. 3, color and brightness of LEDs and strings of LEDs may be controlled as a function of power dissipation in individual LEDs 340, 341 and 342. Excitation of LEDs can be configured to obtain a selected product of current and voltage over an interval of time that can be used to obtain desired color and brightness characteristics of light emitted from LEDs 340, 341 and 342.

In the example of FIG. 3, LEDs 340, 341 and 342 may be red green and blue LEDs, connected in series to reduce power loss. The example of RGB LEDs is provided to illustrate the case of LEDs having different operating characteristics, but LEDs 340, 341 and 342 can just as well comprise WLEDs, strings of RGB LEDs and combinations of WLEDs and RGB LEDs. LED driver 32 may comprise any combination of ICs and discrete components and, as illustrated in the example depicted, can be implemented in a single IC 32. In certain embodiments, IC 32 may include LED switches 320, 321 and 322 that are configured to permit differing power dissipation in each of LEDs 340, 341 and 342. Each LED switch 320, 321 and 322 may be connected in parallel with a corresponding LED 340, 341 and 342. LED switches 320, 321 and 322 can be controlled independently of one another using binary digital switching signals 370, 371 and 372 that may be provided by external logic or, in at least some embodiments, by internal logic (not shown). When an individual switching signal 370, 371 or 372 is in a first binary state, corresponding LED switch 320, 321 or 322 is open; when the individual switching signal 370, 371 or 372 is in the other binary state, corresponding LED switch 320, 321 or 322 is closed.

Responsive to the switching signals 370, 371 and 372 the LED switches 320, 321 and 322 typically operate to open and close in a repetitive, pulsed manner. In certain embodiments, switching signals 370, 371 and 372 are provided with a common repetition rate having sufficiently high frequency to avoid ocularly perceptible flicker in light emitted from LEDs 340, 341 and 342. For example, a frequency of 1 KHz may be used to pulse LED switches 320, 321 and 322. When opened, individual LED switches 320, 321 and 322 may permit electrical current to flow through corresponding LEDs 340, 341 and 342. When closed, individual LED switches 114f, 1148, 114b may short across and thereby shunt current around corresponding LEDs 340, 341 and 342. In one example, switching signals 370, 371 and 372 can respectively control the operation of the LED switches 320, 321 and 322 associated with a red LED 340, a green LED 341 and a blue LED 342. These individual LEDs 340, 341 and 342 may be provided with different duty cycles to obtain a desired output of each LED 340, 341 and 342 and provide an output light having a selected color and intensity. FIG. 3 also includes example waveforms 380, 381 and 382 for typical switching signals 370, 371 or 372 for a combination of RGB LEDs.

In certain embodiments, ballast resistors may be omitted and replaced by a DC current generator 36. Current generator may be a circuit comprising, for example, a transistor for sinking or sourcing current and a regulator for maintaining the current at a constant amperage over different operating conditions (e.g. conditions affected by input voltage, temperature, and manufacturing process variations, etc.). In many embodiments, the current generator can receive an enabling input that allows current to be turned on and off Thus, when a pulse width modulated (“PWM”) signal is received as an enabling input, current flow will typically he pulse width modulated.

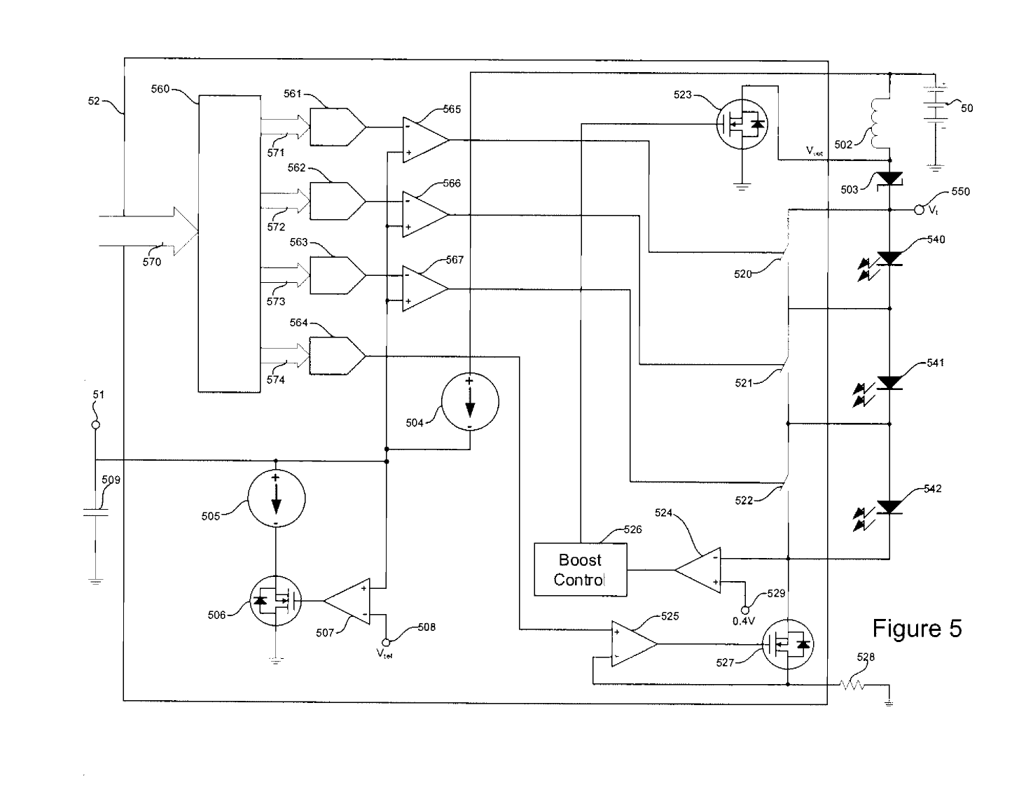

In the example of FIG. 3, current generator 36 is connected in series with LEDs 340, 341 and 342. Although current generator 36 is depicted as being separate from LED driver 32 in the example in FIG. 5, current generator 36 may be incorporated into integrated circuit 32 that also houses LED driver 32. Current generator 36 can typically adjust overall brightness of LEDs 340, 341 and 342 by controlling the amount of current (i_{LED}) flowing in any of series connected LEDs 340, 341 and 342 that are not shunted. Specifically, opening one or more of the LED switches 320, 321 and 322 causes current ILED to flow through an associated one or more LEDs 340, 341 and 342. In one example consistent with operation of FIG. 3, iLED can be caused to flow through selected ones of a red LED 340, green LED 341 and blue LED 342 when associated switches 320, 321 and 322 are opened. Depending upon the duty cycle controlled by the waveforms 380, 381 and 382 of switching signals 370, 371 and 372, a certain RMS current, respectively i_{R}, i_{G} and i_{B}, may be caused to flow through each of RGB LEDs 340, 341 and 342 such that:
i_{R}=d_{R}×i_{LED}
i_{G}=d_{G}×i_{LED}
i_{B}=d_{B}×i_{LED},
where d_{R}, d_{G} and d_{B} are the duty cycles respectively of the RGB LEDs 340, 341 and 342. In this manner, each of series connected RGB LEDs 340, 341 and 342 dissipates different amounts of power depending upon the duty cycles, d_{R}, d_{Q} and d_{B}, of the signals 370, 371 or 372 controlling LED switches 320, 321 and 322. In one application, combinations of duty cycles d_{R}, d_{Q} and d_{B} can be selected for the LED switches 320, 321 and 322 such that the combined RGB LED string emits a desired combined color and intensity of light. Thus, a range of different colors of light—including white light—can be produced using three RGB LEDs 340, 341 and 342.

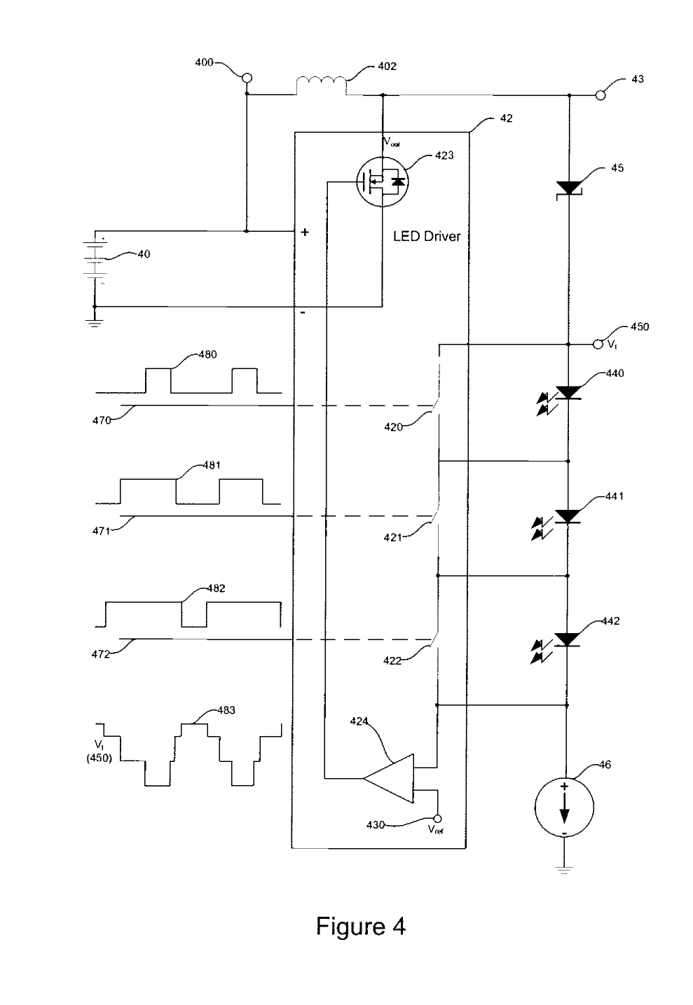

Turning now to FIG. 4, certain embodiments provide an energy efficient LED driver circuit that dynamically adapts for serially-connected LEDs. Typically, battery voltage must be boosted to levels determined by the LED configuration. For example, where LEDs 440, 441 and 442 are RGB LEDs, a 1.5 v to 4.2 v battery voltage may be boosted to at least 10 v for three series connected RGB LEDs. In another example, the 1.5 v to 4.2 v battery voltage to at least 16 v for 4 WLEDs. Furthermore, series connected combinations of WLEDs, RGB LEDs and other LEDs may require voltage boosting of battery voltage to other voltage levels. In the example depicted in FIG. 4, voltage boost requirements vary as LEDs 440, 441 and 442 are switched in and out of circuit.

Voltage boosting may be accomplished using a charge pump, boost converter, or any suitable DC to DC voltage level converter. In the example of FIG. 4, LED driver 42 may include a comparator 424 that compares voltage across a DC current generator 46 to a reference voltage (VREF) 430. Comparator 424 can provide an output signal that controls operation of voltage-boost switch 423. In the example provided in FIG. 4, the polarity of the battery 52 indicates the use of an N-type MOSFET to serve as voltage-boost switch 423. Accordingly, the output of comparator 424 can be coupled to gate terminal of voltage-boost switch 423. Drain terminal of voltage-boost switch 423 can be provided as boosted output 43 of LED driver 42. Inductor 402 is typically connected between input 400 and boosted output 43 and a Schottky diode 45 may be provided to connect between boosted output 43 and series-connected LEDs 440, 441 and 442.

In certain embodiments, adaptive boost converter operates to provide voltage Vₜ 450 to the combination of series connected LEDs 440, 441 and 442 and current generator 46. Voltage Vₜ 450 is typically variable such that the adaptive boost converter produces a minimum desired voltage Vₜ 450 that provides at least the minimum bias voltage required for proper operation of current generator 46. In the example, the minimum bias voltage is 0.4V. The adaptive boost converter can ensure that current generator 46 functions within rated operating tolerances. Voltage Vₜ 450 may continuously vary in response to changes in the logic condition of switching signals 470, 471 and 472 and may track the repetition rates applied to various LED switches 420, 421 and 422. For example, whenever one of the LED switches 420, 421 and 422 closes, voltage Vₜ 450 may drop to a voltage level sufficient to energize those of LEDs 440, 441 and 442 associated with any of LED switches 420, 421 and 422 that remain open. Similarly, whenever an additional one of LED switches 420, 421 and 422 opens, voltage Vₜ may increase to exceed a minimum voltage level required to energize the additional LEDs. FIG. 4 includes an example of a typical waveform 483 for voltage Vₜ 450.

In certain embodiments, the adaptive boost converter can ensure that the voltage Vₜ 450 applied to the circuit comprising series connected LEDs 440, 441 and 442 and current generator 46 may be maintained near to the minimum voltage required to energize those LEDs of LEDs 440, 441 and 442 that are active and to maintain sufficient bias voltage required to ensure proper operation of current generator 46. Accordingly, an adaptive boost converter such as that depicted in FIG. 4 can maximize power efficiency in powering LEDs (both RGB LED and WLED) 440, 441 and 442 and can therefore lengthen battery life.

FIG. 5 includes an example of a block diagram for an LED driver IC 52 that implements the adaptive boost converter depicted in FIG. 4. IC 52 typically comprises a serial digital interface 560 that can exchange data with a serial digital data bus 570 or other serial communications channel. One example of a serial digital data bus 570 is provided by the Phillips' I²C bus as described in U.S. Pat. No. 4,689,740, but any other analogous digital data bus adapted for serial data communication will suffice. Serial digital interface 560 can typically store certain digital data received from serial digital data bus 570. This stored data may include configuration and control information that specifies relative proportions of light to be produced by each of LEDs 540, 541 and 542 or for a string of LEDs. In one example, LEDs 540, 541 and 542 may comprise red, green and blue LEDs and the stored data may include information specifying a desired color and intensity, relative output levels desired of each of LEDs 540, 541 and 542, desired output levels for each of LEDs 540, 541 and 542 or an overall brightness of light desired. In another example, all of LEDs 540, 541 and 542 in a string can have uniform color including, red green, blue or white and the stored data may include information specifying desired intensity levels for each of LEDs 540, 541 and 542, intensity levels for each of LEDs 540, 541 and 542 and correction factors to ensure consistent light production across the string or an overall light intensity for one or more strings.

In certain embodiments, an overall brightness of LEDs 540, 541 and 542 can be communicated from serial digital interface 560 to a brightness digital-to analog converter (“DAC”) 564 using a brightness bus 574. Brightness DAC 564, responsive to the brightness data, may produce a brightness analog signal transmitted from an output of brightness DAC 564 to non-inverting input of comparator 525. Comparator 525 may compare the brightness signal to a terminal of current sensing resistor 528 that may be provided externally or internally to the LED driver IC 52. Comparator 525 can be an integral part of a current generator. It will be appreciated that the resistance value of current sensing resistor 528 may be selected to be sufficiently small such that the voltage across current sensing resistor 528 is relatively low to minimize power loss. For example close to 0.1 volt when any of LEDs 540, 541 and 542 is energized. An output of comparator 525 may be connected to a gate terminal of an N-type MOSFET 527 which may also be provided as part of a current generator. N-type MOSFET 527 may be used to connected series connected LEDs 540, 541 and 542 to current sensing resistor 528.

Continuing with the example of FIG. 5, an output of comparator 524 supplies a minimum voltage detect output signal to boost control circuit 526 indicating whether the bias voltage of N-type MOSFET 527 exceeds a predetermined threshold voltage 529, here 0.4V. Boost control circuit 526 may produce a modulated boost control signal, such as a digital pulse width modulated, that can be supplied to the gate of voltage-boost switch 523. This boost control signal provided to gate of switch 523 can cycle the voltage-boost switch 523 between on and off conditions. The boost control signal typically cycles the voltage-boost switch 523 at a frequency which is significantly higher than the 1.0 KHz repetition rate selected for controlling operation of LED switches 520, 521 and 522, which can be in the 1.0 MHz range. In the LED driver IC 52 of the example, LED switches 520, 521 and 522 can be implemented as high power P-type MOSFET switches. Thus, in certain embodiments, brightness data stored in serial digital interface 560 can control the amount of current flowing through certain of the series connected LEDs 540, 541 and 542 based on the condition of the LED switches 520, 521 and 522. By controlling the operation of switches 520, 521 and 522 and current level set by MOSFET 527, overall brightness of light produced by LEDs 540, 541 and 542 may be controlled.

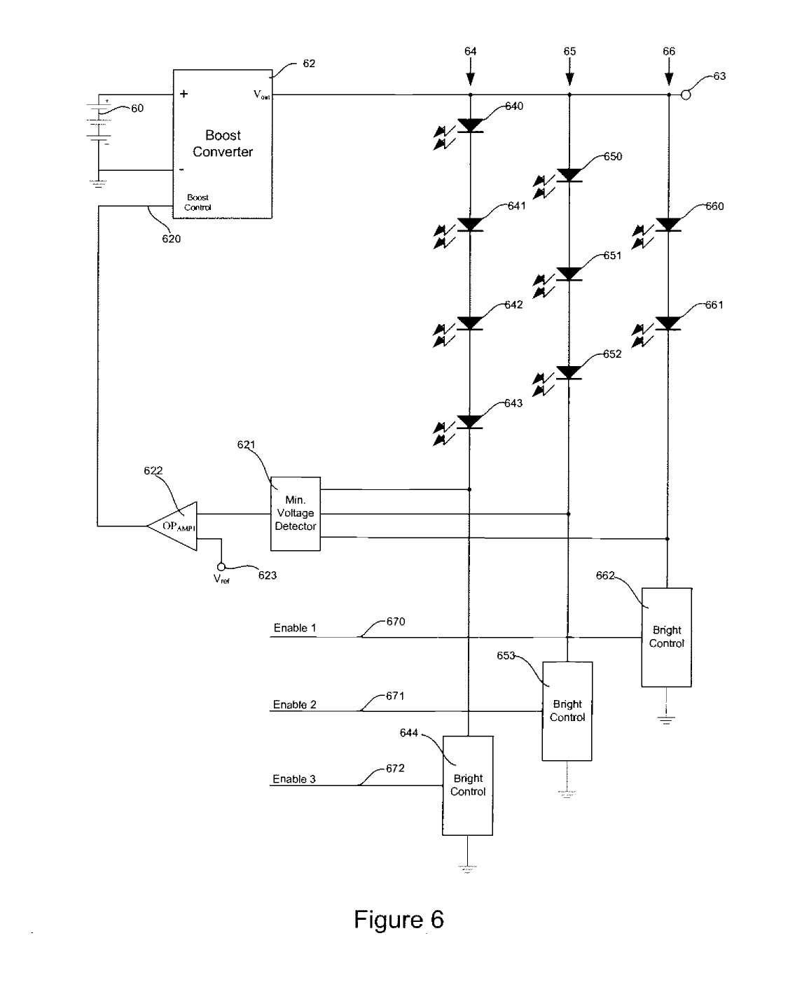

In certain embodiments, the output level of light produced respectively by each of LEDs 540, 541 and 542 can be controlled using separate DACs 561, 562 and 563 to control operation of switches 520, 521 and 522 based on brightness information maintained in serial digital interface 560. For example, in an RGB string of LEDs, serial digital interface 560 can transmit digital data for red, green and blue LEDs (in this example, LEDs 540, 541 and 542) using corresponding busses 571, 572 and 573, respectively. Thus, each switch 520, 521 and 522 can be controlled using a corresponding DAC 561, 562 and 563. Analog LED-control output-signals may be produced by DACs 561, 562 and 563 and transmitted to corresponding ones of switch control comparators 565, 566 and 567. LED driver IC 52 may generate, receive or otherwise obtain a signal having a triangular waveform and provide this triangular waveform to the switch control comparators 565, 566 and 567. The triangular-waveform signal typically has a frequency equal to the 1.0 KHz repetition rate for signals that control the operation of the LED switches 520, 521 and 522 (see, e.g., waveforms depicted in FIGS. 5 and 6).

In certain embodiments, LED driver IC 52 may include series connected current generators 504 and 505 for producing the triangular waveform signal. In certain embodiments, an input to current generator 504 can be connected to the battery 50 and an output of current generator 504 may be connected to the input of current generator 505. An output of the current generator 505 may be connected to drain terminal of N-type MOSFET 506 that is typically included in the triangular waveform generator. Source terminal of N-type MOSFET 506 can be connected to circuit ground. The current generators 505 and 506 are typically constructed so that the current that flows through current generator 506 when N-type MOSFET 256 is turned-on is twice as much as the current that flows continuously through current generator 506.

Continuing with the example, one terminal of capacitor 509, typically located outside LED driver IC 52, connects to the output of current generator 504. The triangular waveform generator of the LED driver IC 52 may also include comparator 507 having non-inverting input that also connects to the output of current generator 504 and having a reference voltage, (V_{Ref}) connected to an inverting input of comparator 507 . An output of comparator 507 connects to the gate of N-type MOSFET 506. The resulting triangular-waveform signal 51, observed at the connection between current generators 504 and 505 can be provided to switch control comparators 565, 566 and 567.

The above described circuit operates as follows. When the output signal from the comparator 507 causes N-type MOSFET 506 to turn off, current from current generator 504 flows mainly into capacitor 509 thereby continuously increasing the voltage of triangular-waveform signal 51. When the voltage across capacitor 509 exceeds the reference voltage V_{Ref} 508, comparator 507 switches and its output signal turns N-type MOSFET 506 on. Turning N-type MOSFET 506 on can cause a doubling of current flowing between current generators 504 and 505 thereby causing a continuous decrease in voltage across capacitor 509 until the output of comparator 507 reverses turning N-type MOSFET 506 off. Hysteresis in the operation of comparator 507 determines the amplitude of the signal having a triangular waveform. The capacitance of capacitor 509 typically determines the frequency of the triangular-waveform signal, and the capacitance is typically selected to yield a frequency near 1 KHz.

Responsive to the analog control signals produced by DACs 561, 562 and 563 and to the triangular-waveform signal 51, switch control comparators 565, 566 and 567 produce digital switch-control signals that are provided to control the operation of switches 520, 521 and 522. Switches 520, 521 and 522 are typically high power P-type MOSFET switches.

Therefore, the data stored in serial digital interface 560 can cause switch control comparators 565, 566 and 567 to cycle the LED switches 520, 521 and 522 on and off at a repetition rate which is the same as the frequency of the triangular waveform signal. The data stored in the serial digital interface 560 may determine a duration during which each of the LED switches 520, 521 and 522 is turned-on during each cycle of the triangular waveform. This determination, in turn, selects the relative proportion of light to be produced by each of the LEDs 540, 541 and 542.

Turning now to FIG. 6, an example of a configuration of white WLEDs 66 such as might be provided in a hypothetical cell phone is illustrated. The hypothetical cell phone includes two backlit panels, such that a main panel can be illuminated when a call is received and a secondary panel can be illuminated during standby operation to display, date and time, etc. Cell phones can also include some other functions that require illumination, including the keyboard, photo-flash, flashlight, etc. In the example illustrated in FIG. 6, a first string 64 of four series connected WLEDs 640, 641, 642 and 643 might be employed to illuminate the cell phone main display panel. A second string 65 of three series connected WLEDs 650, 651 and 652 might be used to illuminate a secondary display panel. A third string 66 of two series connected WLEDs 660 and 661 may illuminate the keyboard, the photo-flash or the flashlight.

Strings 64, 65 and 66 can be connected in parallel between the LED power output terminal 63 of voltage boost converter 62 and LED brightness controllers 644, 653 and 662. Each of the brightness controllers 644, 653 and 662 may receive control signals 670, 671 and 672 for controlling the power dissipated in corresponding WLED strings 64, 65 and 66. Control signals 670, 671 and 672 can turn the WLED strings 64, 65 and 66 off and on at frequencies selected to eliminate visible flicker and can therefore control apparent brightness of light emitted by the respective strings of WLED 64, 65 and 66. It will be appreciated that, although depicted individually in FIG. 8, boost converter 62 and brightness controllers 644, 653 and 662 may be collocated in a single IC.

LED driver 42 of FIG. 4 may be used for controlling operation of strings 64, 65 and 66 illustrated in FIG. 6. In some embodiments, LEDs 440,441 and 442 of FIG. 4 may be replaced with strings of LEDs 64, 65 and 66. However, where LED driver 42 is used for controlling operation of strings 64, 65 and 66, then a comparatively high voltage must be provided as output 63 of boost converter 62 when all strings 64, 65 and 66 are concurrently turned on.

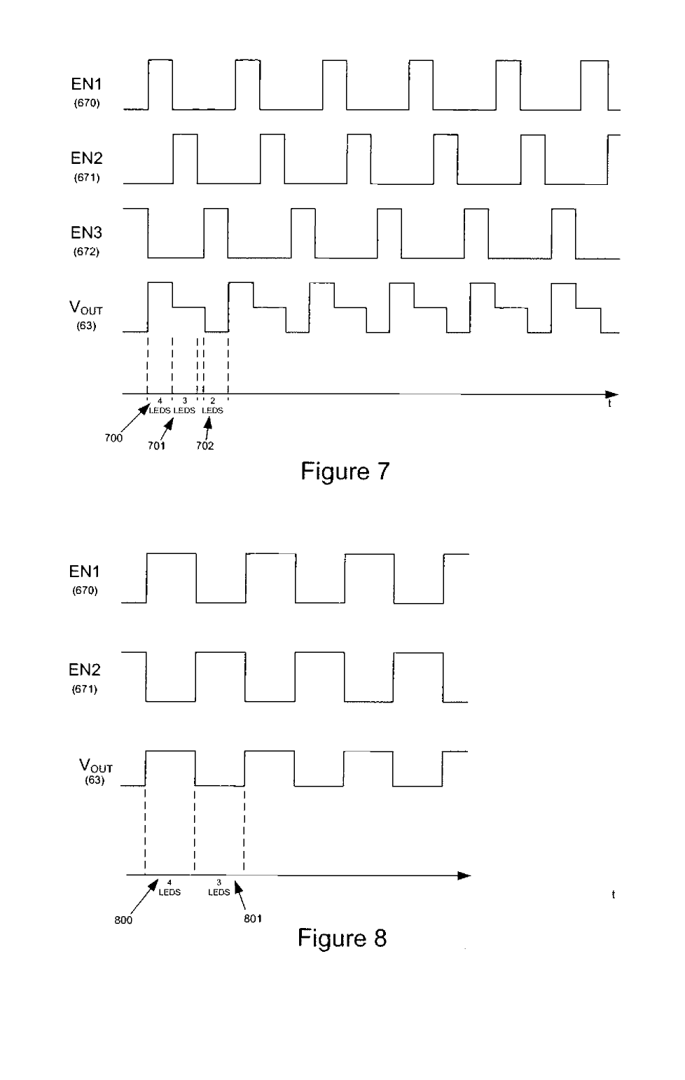

To reduce the required voltage, certain embodiments employ interleaved control signals 670, 6711 and 672. Interleaved control signals 670, 671 and 672 may be generated internally or received from external sources. Referring also to FIGS. 7 and 8, certain embodiments enable LED strings 64, 65 and 66 sequentially and independently of one another. For example, when a first string 64 is turned on and the other strings 65 and 66 are turned off, internal pull-up devices maintain signals 651 and 652 at or near the output 63 of boost converter 62. It will be appreciated that suitable pull-up devices include fixed current generators or resistors connected to output 63 of boost converter 62. As a result, only the voltage measured on brightness controller (VD₁) 644 is used by the minimum voltage detector to control operation of boost converter 62. The operation of boost converter 62 is controlled to produce an output voltage 63 suitable for driving the first string of LEDs 64.

Control of the boost converter 62 can be effected using Op Amp 662 which can be used maintains VD₁=V_{ref}. In the example, Op Amp 662 limits boost output voltage (V_{OUT}) 63 from increasing higher than V_{OUT}=V_{ref}+4×V_{led}, where V_{led} represents the voltage dropped on each LED device when turned on. As V_{OUT} 63 approaches this maximum value, Op Amp 662 causes the duty cycle of the boost controller to be reduced causing V_{OUT} 63 to drop. As V_{OUT} 63 drops below V_{ref}+4×V_{led}, Op Amp 662 can then increase the duty cycle of the boost controller in order to increase V_{OUT} 63 and keep V_{DI}=V_{ref} near to a constant value. It will be appreciated that, in this example, Op Amp 662 is part of a negative feedback loop in the boost controller.

It will be appreciated that a similar analysis may be applied when second string 65 is turned on and strings 64 and 66 are turned off. In this case, V_{OUT} will be maintained at a level determined by: V_{OUT}=V_{ref}+3×V_{led}. Likewise, when third string 66 is turned on and strings 64 and 65 are turned off, V_{OUT} will be maintained at a level determined by: V_{OUT}=V_{ref}+2×V_{led}.

Referring to FIGS. 6-8, FIG. 7 illustrates a typical full period waveform of V_{OUT} for three strings 64, 65 and 66 enabled by signals EN1, EN2, and EN3. FIG. 8 illustrates a typical full period waveform of V_{OUT} for two strings 64 and 65 enabled by signals EN1 and EN2. As can be appreciated, interleaving enable signals 670, 671 and 672 as shown in FIG. 7 ensures that only one of brightness controllers 644, 653 and 662 permit current to flow in only one of LED strings 64, 65 and 66 at any time. Different voltages will typically be required voltage required to drive each of LED strings 64, 65 and 66 when, as shown, different quantities of LEDs are provided in the LED strings 64, 65 and 66 or when the LEDs in the LED strings 64, 65 and 66 have different characteristics. Thus, V_{OUT} 53 may have a staircase or other stepped form. In certain embodiments, the interleaving sequence of enable signals 670, 671 and 672 may be selected to obtain certain desirable characteristics such as frequency of the interleave “ripple” or stepping. Additionally, the duty cycle of boost control signal 620 to boost converter 62 can vary for each period of interleave. For example, when driving LED string 64, boost control 620 may be enabled for a longer period than would be needed for driving LED string 66 because of the different voltages needed for driving four and two LEDs.

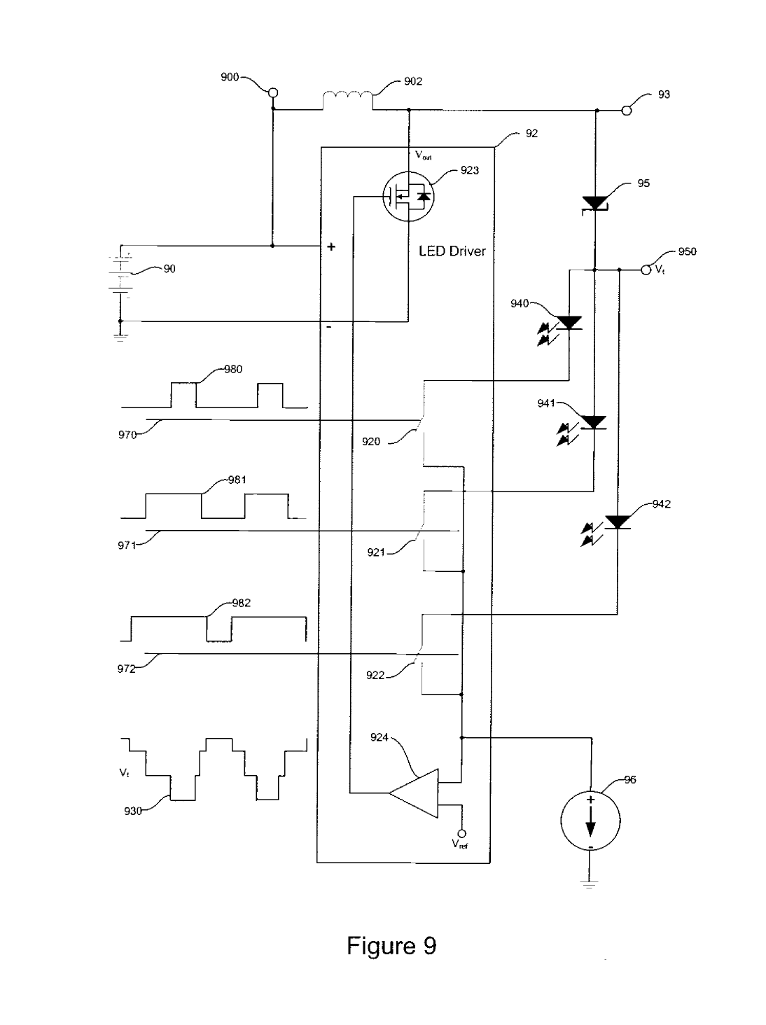

FIG. 9 depicts an example of an embodiment of an LED driver 92 configured for more efficiently controlling operation of strings 940, 941 and 942 (each depicted for simplicity as a single LED). In the example of FIG. 9, each of strings 940, 941 and 942 may include one or more LEDs, wherein the LEDs may include WLEDs, RGB LEDs. LED driver 92 comprises LED switches 920, 921 and 922, each switch 920, 921 and 922 connected in parallel with a corresponding one of strings 940, 941 and 942. Each string 940, 941 and 942 receives the output 93 of voltage boost circuitry through Schottky diode 95 and each string 940, 941 and 942 is connected to current generator 96. Although depicted as separate from LED driver 92, the DC current generator 96 can also be provided as part of LED driver 92.

In the example, individual switch control signals 970, 971 and 972 maybe configured to sequentially and repetitively close each LED switch 920, 921 and 922 while maintaining the other two LED switches 920, 921 and 922 open. Thus, at any instant in time electrical current flows through only one of strings 940, 941 and 942. LED driver 92 continuously adjusts output voltage 93 to meet minimum voltage requirement for energizing currently enabled LED string 940, 941 or 942, the LED driver 92. Minimum voltage requirement is calculated based on the number of LEDs in the string 940, 941 or 942 currently active, together with the bias voltage required to ensure proper operation of the current generator 96. Accordingly, LED driver 92 can optimize power dissipation in operating strings 940, 941 and 942 and can lengthen battery life.

Generally, the human eye cannot discern flicker in a light blinking at a frequency higher than 150 Hz. Therefore, if each of strings 940, 941 and 942 are turned off and on with a frequency higher then 150 Hz, then the human eye perceives output light as being emitted continuously. Accordingly, switch control signals 970, 971 and 972 are typically configured to supply pulses of electrical current to strings 940, 941 and 942 at a frequency which exceeds 200 Hz to ensure that a viewer experiences no discomfort due to pulsation of light emitted by the strings 940, 941 and 942.

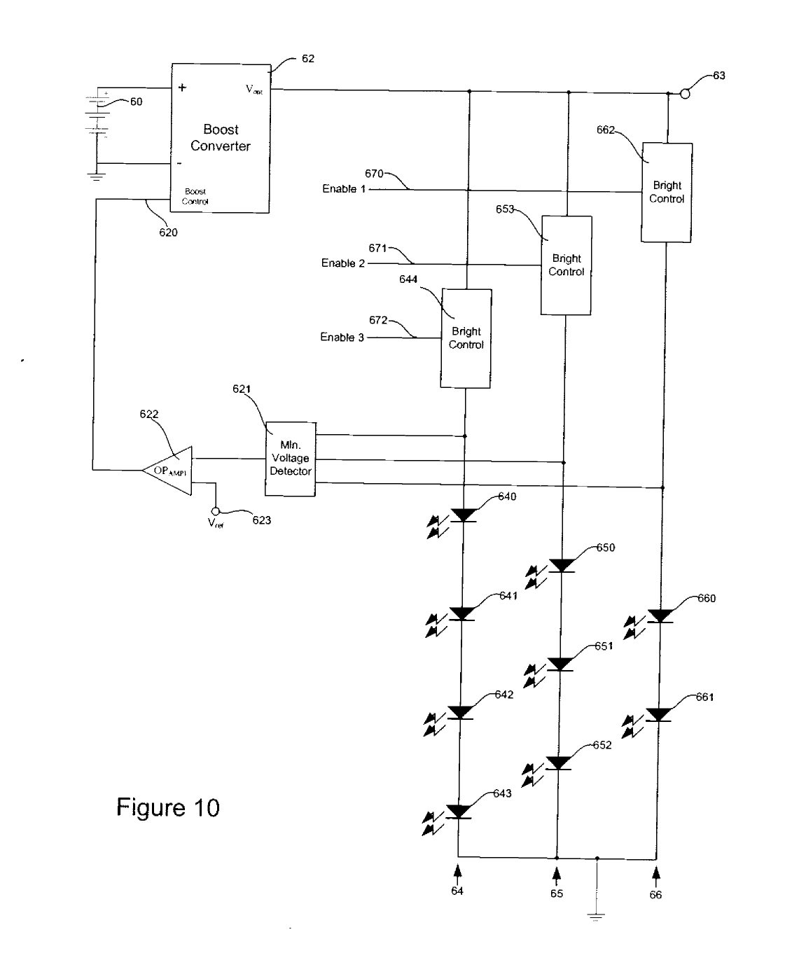

An example of another embodiment is provided in FIG. 10. Strings of LEDs 64, 65 and 66 are connected to ground in a common cathode topology while corresponding current generators 644, 653 and 662 are connected to the output V_{OUT} 63 of boost converter 62. Each current generator 644, 653 and 662 sources current into its corresponding string of LEDs 64, 65 and 66. It will be appreciated that, in this embodiment, a PMOS transistor (not shown) may replace NMOS transistor 527 (see FIG. 5) in the current generators 644, 653 and 662 for providing minimum voltage detect signals to detector 621. Boost converter 62, OP_{AMP1} 622, minimum voltage detector 621 and enable signals 670, 671 and 672 operate in similar fashion to the equivalent components of the embodiment illustrated in FIG. 6 and described above. As in the embodiment of FIG. 6, enable signals 670, 671 and 672 and the output voltage V_{OUT} 63 of FIG. 10 typically have waveforms similar to those illustrated in FIGS. 7 and 8.

Although the present invention has been described in terms of the presently preferred embodiment, it is to be understood that such disclosure is purely illustrative and is not to be interpreted as limiting. The various examples depicted only one, two or three strings wherein the strings had between One and four LEDs. However these configurations were selected to minimize complexity in describing certain aspects of the invention. However, the present invention is not limited to such described configurations. Likewise, variations in the types and frequency of modulation used to control LED output and various forms and frequencies of switching signals are contemplated. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof.

What is claimed is:

1. An LED driver comprising:
a plurality of current generators, each coupled to a corresponding string of LEDs and configured to control current in the corresponding string of LEDs; and
a boost converter configured to provide power to the strings of LEDs at a voltage sufficient to maintain a minimum operating voltage across each of the plurality of current generators;
wherein each of the plurality of current generators modulates current in the corresponding string of LEDs responsive to a pulsed signal received by the each current generator.

2. The LED driver of claim 1, wherein the voltage is increased when voltage measured across any current generator falls below the minimum operating voltage.

3. The LED driver of claim 1, wherein each of the plurality of current generators receives a different pulsed signal.

4. The LED driver of claim 3, and further comprising a signal generator for providing the different pulsed signals.

5. The LED driver of claim 1, wherein the each current generator permits current to flow in the corresponding string of LEDs only when the pulsed signal is in one of two binary states.

6. The LED driver of claim 5, wherein each of the plurality of current generators receives a different pulsed signal, and wherein the different pulsed signals are pulse width modulated.

7. The LED driver of claim 5, wherein each of the plurality of current generators receives a different pulsed signal, and wherein the different pulsed signals are interleaved.

8. The LED driver of claim 1, wherein the boost converter and current generator are provided in a common integrated circuit.

9. The LED driver of claim 3, and further comprising a signal generator for providing a different pulsed signal to each of the plurality of current generators, each of the different pulsed signals having a predetermined duty cycle.

10. An LED driver comprising:
a current generator coupled to a string of LEDs and configured to control current in the string of LEDs; and
a boost converter configured to provide power to the string of LEDs at a voltage sufficient to maintain a minimum operating voltage across the current generator; and
a plurality of bypass switches, each switch configured to permit selective bypass of one LED in the string of LEDs.

11. The LED driver of claim 10, wherein the boost converter and current generator are provided within a common integrated circuit.

12. The LED driver of claim 10, wherein each switch is opened and closed responsive to a corresponding one of a plurality of pulsed bypass signals.

13. The LED driver of claim 12, and further comprising
storage for maintaining a configuration for controlling light output of the string of LEDs; and
a data input for receiving the configuration, wherein
duty cycles of the plurality of pulsed bypass signals are determined by the configuration.

14. The LED driver of claim 13, wherein the string of LEDs includes two or more different colored LEDs and color of the output of the string of LEDs is determined by the configuration.

15. The LED driver of claim 13, wherein the data input is a digital serial bus.

16. The LED driver of claim 12, wherein the plurality of pulsed bypass signals are pulse width modulated.

17. An LED driver comprising:
a plurality of current generators each current generator being connected in serial to a corresponding one of a plurality of strings of LEDs, wherein each current generator is configured to control current in the corresponding string of LEDs;
a boost converter having an output for driving the plurality of strings of LEDs; and
a voltage regulator and a minimum voltage detector for controlling the boost converter and operative to maintain a desired voltage across one or more of the plurality of current generators; wherein,
enabling pulse signals alternately turn corresponding ones of the plurality of current generators on and off on a time basis sequence, and wherein
each pulse signal operates to modulate light output of a corresponding string of LEDs.

18. The LED driver of claim 17, wherein the voltage regulator includes an Op Amp.

19. The LED driver of claim 18, wherein the voltage detector is configured to provide an indication of a low voltage condition across any of the plurality of current generators and wherein low voltage conditions are measured across sourcing transistors in the plurality of current generators.

20. The LED driver of claim 18, wherein the voltage detector is configured to provide an indication of a low voltage condition across any of the plurality of current generators and wherein low voltage conditions are measured across sinking transistors in the plurality of current generators.
